(19) United States
(12) Patent Application Publication
(10) Pub. No.: US 2010/0034668 A1
(43) Pub. Date: Feb. 11, 2010

(54) VACUUM PUMPING SYSTEM WITH A PLURALITY OF SPUTTER ION PUMPS

(76) Inventors: Gianfranco Cappuzzo, Torino (IT); Cristian Macarrone, Torino (IT); Michele Mura, Torino (IT)

Correspondence Address: Varian Inc.;Legal Department, 3120 Hansen Way D-102, Palo Alto, CA, 94304, US

(21) Appl. No.: 12/537,159

(22) Filed: Aug. 6, 2009

(30) Foreign Application Priority Data
Aug. 8, 2008 (EP) 08425560.3

(51) Int. Cl. H01J 41/20

(52) U.S. Cl. 417/49

(57) ABSTRACT

In a vacuum pumping system with a plurality of sputter ion pumps the considerable reduction in its overall axial size and weight is achieved by utilizing a plurality of axially superimposed sputter ion pumps and a common magnetic circuit, which comprises a pair of external magnets located at opposite axial ends of the pumping system, one or more intermediate magnets arranged alternated with the sputter ion pumps and a ferromagnetic yoke, internally enclosing the external magnets and the one or more intermediate magnets.

### CROSS REFERENCE TO RELATED APPLICATIONS

This patent application claims priority to European Patent Application No. 08425560.3 as filed on Aug. 8, 2008.

### BACKGROUND OF THE INVENTION

The present invention relates to a vacuum pumping system comprising a plurality of sputter ion pumps.

As known, and referring to FIG. 1, a sputter ion pump 10 is a device for producing high-vacuum conditions, which comprises a vacuum housing 30 accommodating at least an anode formed by a plurality of hollow cylindrical pumping cells 50, and a cathode formed by plates 70, e.g. of titanium, located at opposite ends of cells 50. Pump 10 includes means 90 for applying a higher potential to the anode than to the cathode. During operation, when a difference of potential (typically, 3-9 kV) is applied between the anode and the cathode, a region of strong electric field is generated between anode cells 50 and cathode plates 70, with the consequent emission of electrons from the cathode that then are captured in anode cells 50. The electrons collide with and ionise the molecules of the gas within pumping cells 50. Because of the electric field, the positive ions thus formed are attracted by cathode plates 70 and impinge against the surface thereof. Ion collision against the titanium plates produces the sputtering phenomenon, i.e. the emission of titanium atoms from the cathode surface. The sputtered titanium is continuously deposited on the anode and the other pump surfaces, where it chemically reacts with the gas molecules present inside the vacuum chamber thereby forming a solid compound, or it buries the gas molecules that do not chemically react with titanium.

Always in accordance with the prior art, sputter ion pumps are equipped with a magnetic circuit comprising a pair of primary magnets 110 located outside housing 30, at opposite axial ends of pumping cells 50, and a ferromagnetic yoke 130. The polarities of magnets 110 are oriented in the same direction, so that a magnetic field parallel to the axes of pumping cells 50 (arrow M) is generated, which allows imparting helical trajectories to the electrons, thereby increasing the lengths of their paths between the cathode and the anode and hence the possibility of collision with the gas molecules and ionisation of said molecules. Ferromagnetic yoke 130 closes the magnetic circuit, by providing a return path for the magnetic field between primary magnets 110 (arrows Y).

In certain applications, a single vacuum pump is not sufficient to attain the desired performance. By way of example, the pumping systems with a plurality of sputter ion pumps are required in applications where vacuum chambers communicating e.g. through an orifice should provide different vacuum degrees. This is for instance the case of the field of high-precision electron microscopes, where toroidal sputter ion pumps are used, which are arranged axially superimposed around the microscope column in order to create different vacuum degrees in respective chambers.

According to the prior art, as shown in FIG. 2, where a cross-sectional view of part of a pumping system comprising toroidal ion pumps with symmetry axis SA is illustrated, such a pumping system is obtained by simply juxtaposing two or more ion pumps 10′, 10″, each having a respective magnetic circuit formed by primary magnets 110′, 110″ and by the corresponding ferromagnetic yokes 130′, 130″. Clearly however such a solution is not optimised and entails a number of drawbacks, above all an excessive axial size. On the other hand, in certain applications, including the example mentioned above of high-precision electron microscopes, the system structure does not provide sufficient space for accommodating a plurality of separate ion pumps.

U.S. Pat. No. 5,324,950 discloses a pumping system comprising a pair of sputter ion pumps, each having its own pair of primary magnets. A common magnetic yoke encloses both pumps and includes a pair of external plates and an intermediate separation plate between the two pumps. Yet, also such a solution is not optimal as far as the reduction of the axial size and the overall weight of the pumping system is concerned.

### SUMMARY OF THE INVENTION

Therefore, it is the main object of the present invention to obviate the above drawbacks of the prior art by providing a vacuum pumping system comprising a plurality of sputter ion pumps, which is as compact and light as possible.

The above and other objects are achieved by the pumping system according to the invention, as claimed in the appended claims.

The pumping system according to the invention is extremely compact and light due to use of a common magnetic circuit comprising a pair of external magnets and intermediate magnets being alternated with the ion pumps.

Advantageously, the provision of the intermediate magnets enables the lines of flux of the magnetic field to remain substantially parallel to the axes of the anode cells, by reducing the tendency of the lines of flux to spread towards the pump outside.

According to a preferred embodiment of the invention, the intermediate magnets are axially movable and therefore they can be moved towards the external magnets or away therefrom, whereby different conditions of magnetic field intensity can be generated and sputter ion pumps with different axial sizes can be accommodated.

Advantageously, in this manner, the pumping speed may be optimised for different pressures.

### BRIEF DESCRIPTION OF THE DRAWINGS

Further advantages and features of the invention will become more apparent from a detailed description of some preferred embodiments of the invention, given by way of non-limiting examples with reference to the accompanying drawings, in which:

FIG. 1 is a schematic cross-sectional view of a sputter ion pump according to the prior art;

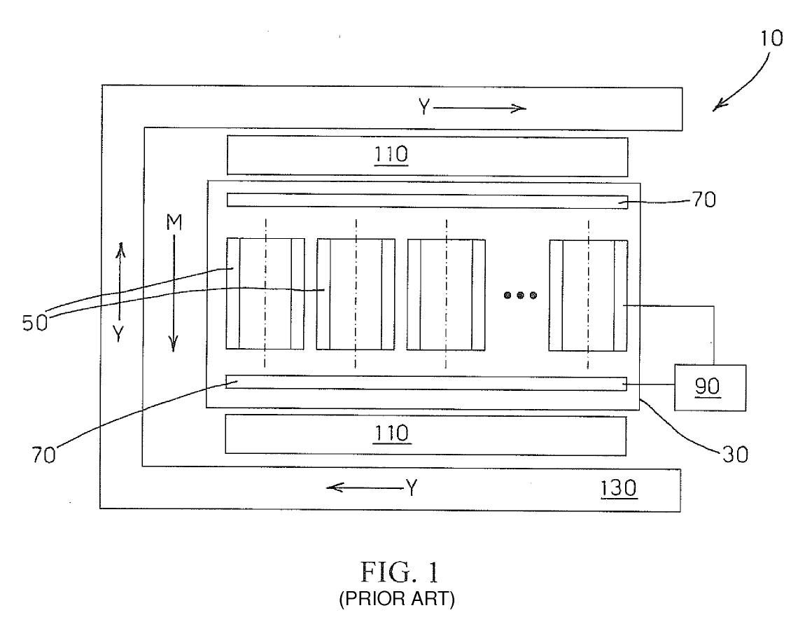

FIG. 2 is a partial cross-sectional view schematically showing a prior art pumping system employing two sputter ion pumps;

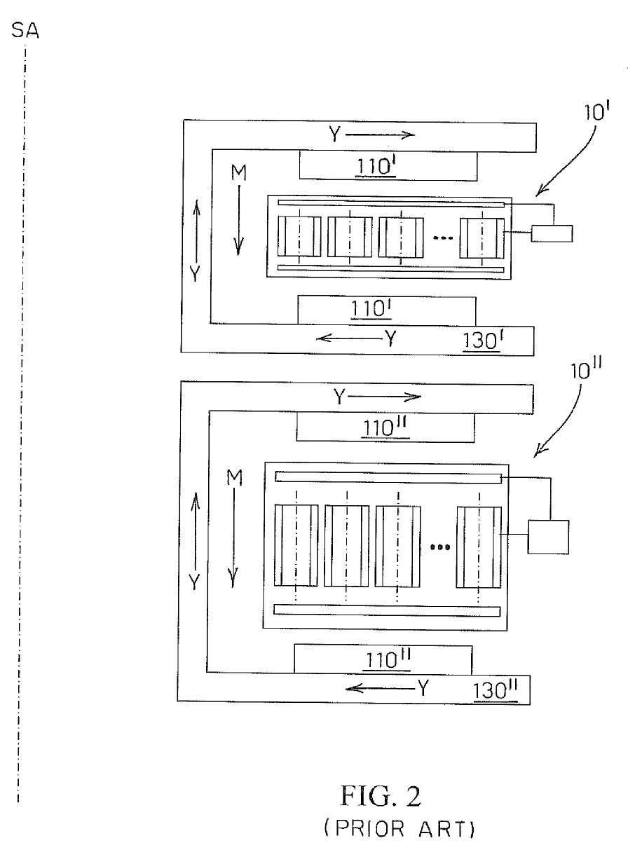

FIG. 3 is a partial cross-sectional view schematically showing a pumping system according to a first embodiment of the invention, employing two sputter ion pumps;

FIG. 4 is a schematic graphical representation of the behaviour of the lines of flux of the magnetic field in the pumping system shown in FIG. 3;

FIG. 5 is a partial cross-sectional view schematically showing a pumping system according to a second embodiment of the invention, employing three sputter ion pumps.

### DETAILED DESCRIPTION OF THE INVENTION

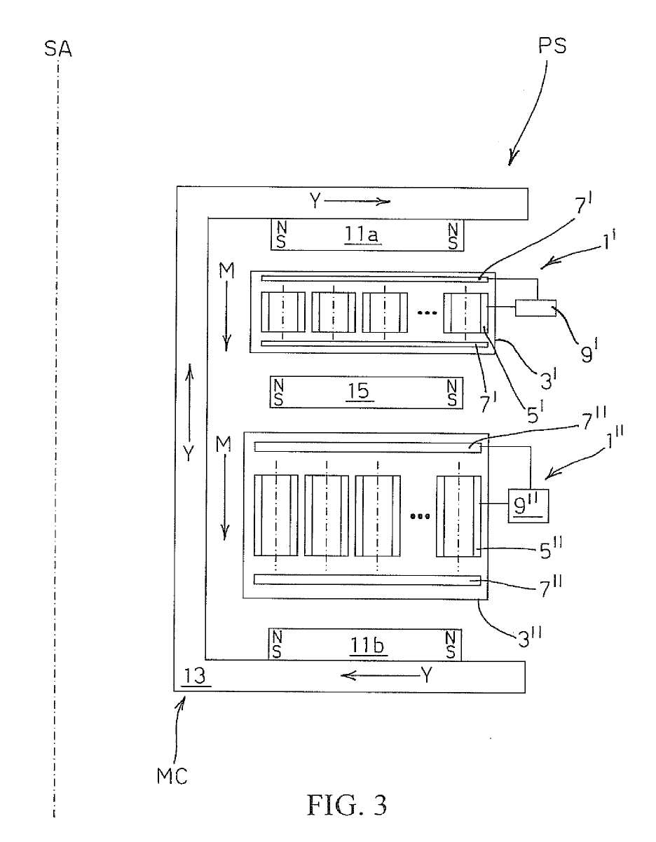

Referring to FIG. 3, there is shown a partial cross-sectional view of a pumping system PS according to the invention, comprising a pair of toroidal sputter ion pumps 1′, 1″ with symmetry axis SA.

In conventional manner, each pump 1′, 1″ comprises an anode formed by substantially cylindrical pumping cells 5′, 5″, and a cathode formed by plates 7′, 7″, e.g. of titanium, located at opposite ends of cells 5′, 5″, both the anode and the cathode being enclosed in a corresponding vacuum housing 3′, 3″. Advantageously, the pumps 1′, 1″ can be separately and independently powered by separate power supply means 9′, 9″.

According to the invention, pumping system PS further comprises a magnetic circuit MC common to both pumps 1′, 1″, the magnetic circuit MC comprising a pair of external magnets 11a, 11b, located at opposite axial ends of pumping system PS and having polarities oriented in the same direction an intermediate magnet 15 interposed between the first ion pump 1′ and the second ion pump 1″ and having polarities oriented in the same direction as the external magnets 11a, 11b. A ferromagnetic yoke 13, internally enclosing the external magnets 11a, 11b and the intermediate magnet 15.

Preferably, external magnets 11a, 11b and intermediate magnet 15 are permanent magnets; in the alternative, they are electromagnets. Since the external magnets 11a, 11b and the intermediate magnet 15 all have polarities oriented in the same direction, they generate a magnetic field parallel to the axes of pumping cells 5′, 5″ of pumps 1′, 1″ (arrows M), whilst ferromagnetic yoke 13 closes common magnetic circuit MC, by providing a return path for the magnetic field between the magnets 11a, 11b, 15 (arrows Y).

In the illustrated example, ferromagnetic yoke 13 is substantially C-shaped, and external magnets 11a, 11b are preferably secured to opposite arms of the C-shaped yoke 13, internally of yoke 13 itself. It is clear that the proposed solution achieves the desired objectives, since it enables obtaining a considerable reduction of both the axial size and the overall weight of pumping system PS.

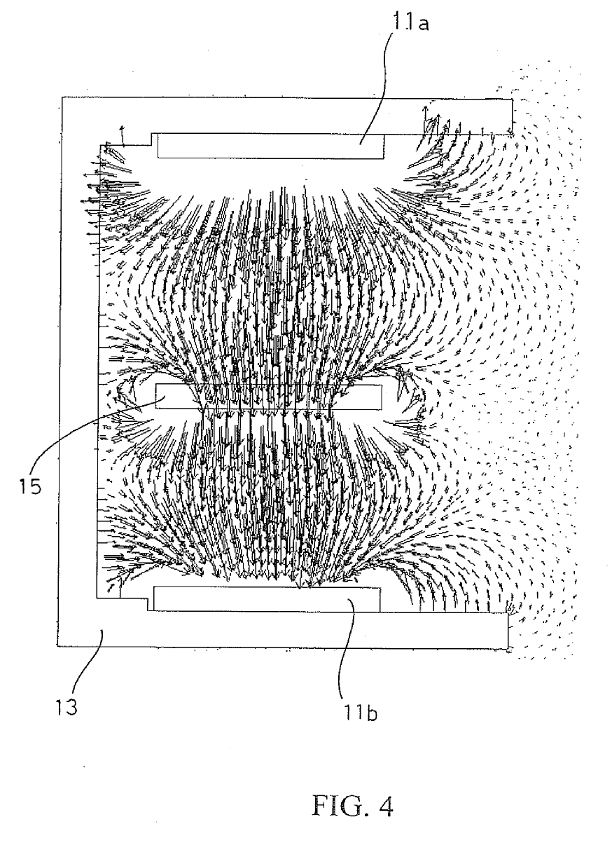

As it can be clearly seen in FIG. 4, where the lines of flux of the magnetic field generated by magnetic circuit MC of pumping system PS according to the invention are schematically shown, the provision of intermediate magnet 15 keeps the lines of flux substantially parallel to the axes of the anode cells and reduces their spread towards the pump outside.

Referring to FIG. 3, it can be appreciated that, according to the preferred embodiment of the invention, intermediate magnet 15 is axially movable relative to external magnets 11a, 11b and to yoke 13, so that it can take a plurality of different axial positions and enables using ion pumps 1′, 1″ with different heights.

As it will be apparent to a person skilled in the art, by axially displacing intermediate magnet 15, it is possible to have different magnetic field intensities in the “pocket” containing the first ion pump 1′ and the “pocket” containing the second ion pump 1″. In this manner, it is possible to have a stronger magnetic field—and hence a higher pumping speed for low pressures (e.g. for ultra-high vacuum degrees)—at the first ion pump 1′, and a lower magnetic field—and a higher pumping speed for high pressures (e.g. for high vacuum degrees)—at the second ion pump 1″, as shown in FIG. 3.

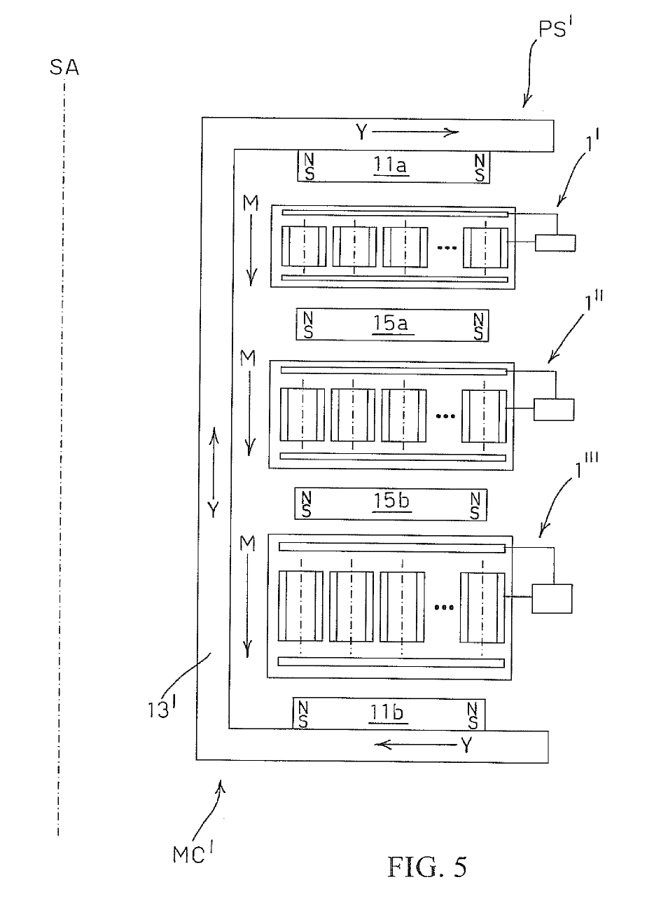

The invention is not limited to a pumping system comprising two ion pumps. By way of example, FIG. 5 shows a partial cross-sectional view of a pumping system PS′ according to a second embodiment of the invention, employing three toroidal sputter ion pumps 1′, 1″, 1′″ with symmetry axis SA.

In this embodiment, magnetic circuit MC′ of pumping system PS′ comprises a pair of external magnets 11a, 11b, located at opposite axial ends of pumping system PS′ and having polarities oriented in the same direction a first intermediate magnet 15a interposed between the first ion pump 1′ and the second ion pump 1″ and a second intermediate magnet 15b interposed between the second ion pump 1″ and the third ion pump 1′″, the intermediate magnets 15a, 15b having polarities oriented in the same direction as the polarities of the external magnets 11a, 11b a ferromagnetic yoke 13′, internally enclosing the external magnets 11a, 11b and said intermediate magnets 15a, 15b.

External magnets 11a, 11b and intermediate magnets 15a, 15b generate a magnetic field oriented parallel to the axes of the pumping cells of pumps 1′, 1″, 1′″ (arrows M), whilst ferromagnetic yoke 13′ closes common magnetic circuit MC′, by providing a return path for the magnetic field between the magnets 11a, 11b, 15a, 15b (arrows Y).

Also in this second embodiment intermediate magnets 15a, 15b can take different axial positions relative to external magnets 11a, 11b and relative to each other, so that they enable accommodating ion pumps 1′, 1″, 1′″ with different heights, each subjected to a magnetic field of different intensity, suitable for the desired pumping speed.

It is clear from the above description that the pumping system can comprise any number of ion pumps, arranged alternated with intermediate magnets. In general terms, the above description has been given by way of non-limiting example and several modifications and variants can fall within the inventive principle upon which the present invention is based.

For instance, as it will be apparent to a person skilled in the art, the intermediate magnets may have the same sizes as, or different sizes from the external magnets depending on the requirements of the specific application. Moreover, always depending on the particular application, the intermediate magnets can be both axially and radially movable.

What is claimed is:

1. A vacuum pumping system (PS; PS′) comprising a plurality of axially superimposed sputter ion pumps (1′, 1″; 1′, 1″, 1′″), each said pump comprising a vacuum housing (3′, 3″) enclosing an anode formed by substantially cylindrical pumping cells (5′, 5″) and a cathode formed by plates (7′, 7″) located at opposite axial ends of said cells (5′, 5″), and power supply means (9′, 9″) for applying a difference of potential between said anode and said cathode, characterised in that the pumping system further comprises a magnetic circuit (MC; MC′), the system comprising:
a pair of external magnets (11a, 11b) located at opposite axial ends of said pumping system (PS; PS′) and having polarities oriented in the same direction;
one or more intermediate magnets (15; 15a, 15b) arranged alternated with said sputter ion pumps (1′, 1″; 1′, 1″, 1′″) and having polarities oriented in the same direction as said external magnets (11a, 11b); and
a ferromagnetic yoke (13; 13′) internally enclosing said external magnets (11a, 11b) and said one or more intermediate magnets (15; 15a, 15b) and providing a return path for the magnetic field generated by said magnets.

2. The vacuum pumping system (PS; PS′) of claim 1, wherein said intermediate magnets (15; 15a, 15b) are axially movable and capable to take a plurality of different axial positions relative to said external magnets (11a, 11b) in order to enable employing sputter ion pumps (1′, 1″; 1′, 1″, 1′″) with different heights.

3. The vacuum pumping system (PS; PS′) of claim 2, wherein said external magnets and said intermediate magnets are permanent magnets.

4. The vacuum pumping system (PS; PS′) of claim 2, wherein said external magnets and said intermediate magnets are electromagnets.

5. The vacuum pumping system (PS; PS′) of claim 2 claim, wherein said ferromagnetic yoke (13; 13′) is substantially C-shaped.

6. The vacuum pumping system (PS; PS′) of claim 5, wherein said external magnets (11a, 11b) are secured to opposite arms of said C-shaped ferromagnetic yoke (13; 13′).

7. The vacuum pumping system (PS; PS′) of claim 1, wherein said sputter ion pumps (1′, 1″; 1′, 1″, 1′″) have separate and independent power supply means (9′, 9″).

8. The vacuum pumping system (PS; PS′) as claimed in any of claims 1 to 7, comprising two sputter ion pumps (1′, 1″) and one intermediate magnet (15) interposed therebetween.

9. The vacuum pumping system (PS; PS′) as claimed in any of claims 1 to 7, comprising three sputter ion pumps (1′, 1″, 1′″), a first intermediate magnet (15a) interposed between said first ion pump (1′) and said second ion pump (1″) and a second intermediate magnet (15b) interposed between said second ion pump (1″) and said third ion pump (1′″).
